(19) United States
(12) Patent Application Publication
(10) Pub. No.: US 2002/0163789 A1
(43) Pub. Date: Nov. 7, 2002

(54) Dust filtering apparatus for a computer system

(76) Inventors: Wang Yu-che, Taipei Hsien (TW); Kao Ming-hui, Taipei Hsien (TW)

Correspondence Address: Michael D. Bednarek, SHAWPITTMAN, 1650 Tysons Boulevard, McLean, VA, 22102-4859, US

(21) Appl. No.: 09/985,085

(22) Filed: Nov. 1, 2001

(30) Foreign Application Priority Data
May 4, 2001 (TW) 090207291

(51) Int. Cl. H01H 1/00

(52) U.S. Cl. 361/812

(57) ABSTRACT

A dust filtering apparatus for a computer system comprising computer housing and a dust filtering apparatus, wherein the computer housing is used to accommodate the computer components of the computer system. The computer housing has a panel. The dust filtering apparatus has an area approximate to the area of that panel. The dust filtering apparatus comprises a first dust filtering member and a second dust filtering member. The first dust filtering member and the second dust filtering member of the dust filtering apparatus are bonded together. The dust filtering apparatus is magnetically attached to the panel of the computer housing and thereby forms a seamless protection to prevent computer components from being contamination by dust particles.

### REFERENCE TO RELATED APPLICATIONS

This application claims benefit of priority under 35 U.S.C. §119(a) of Taiwan Patent Application No. 090207291, filed May 4, 2001.

### BACKGROUND OF THE INVENTION

1. Field of the Invention

The present invention relates to a dust filtering apparatus, in particular to a dust filtering apparatus used for computer system.

2. Description of the Related Art

The operation of computer systems generates a considerable amount of excess heat. Such heat lowers the operating efficiency of the computer system and excess heat can also damage individual computer components. As a result, computer systems commonly use dissipating mechanisms and apparatus to avoid the adverse consequences that can arise from excess heat. An exhaust fan is often used as a dissipating means, where circulating air generated by said fan dissipates heat. Nonetheless, this method of air circulation can also carry dust particles into the computer system via the ventilating openings, disc slot, and the gap between the computer components and computer housing. Over time, the accumulation of dust particles on the surface of computer components may hinder dissipation efficiency and excess heat thereby cause damage to said components.

Among the prior art designs of computer systems for a server, provide a dust filtering apparatus such as a sliding dust cover to protect computer components from dust accumulation. For example, a prior art lift-up dust filtering apparatus is shown in the FIG. 1. The dust filtering apparatus is a lift-up cover 101, pivotally connected to the computer housing 103. When lift-up cover 101 is in a closed position, dust particles are kept from entering into the computer system 104 along with airflow through such unshielded area as optical dist slots and floppy disk drive slots on the panel 102.

In conventional computer dust prevention designs, an add-on detachable dust filtering apparatus is most commonly utilized and usually attached to the computer housing. Computer manufacturers are not only required to make a mold for the production of the dust filtering apparatus, they also need extra labor for the assembly work required to attach the dust filtering apparatus to the computer housing. Consequentially, manufacturing cost goes up. In addition, in order to assure that gap between the dust filtering apparatus and the computer housing is minimized, there is a danger that the dust filtering apparatus may be attached too tightly to the computer housing and thus become inconvenient for users to operate. On the other hand, the dust filtering apparatus may be attached to the computer housing loosely due to an inadequate design, thereby creating gaps that allow the dust to be carried into the computer system.

For manufacturers, the time required for related R&D, product production and cost are the main concerns. Take said lift-up cover for example, it could takes as long as 9 weeks from archetype development to the manufacturing process completion. Extra labor cost for mold design and dust filtering apparatus assembly are also inevitable.

### SUMMARY OF THE INVENTION

The present invention provides a dust filtering apparatus for a computer system, comprising computer housing and a detachable dust filtering apparatus. The detachable dust filtering apparatus is attached to the panel of the computer housing and forms a seamless protection to prevent computer components from being contaminated by dust particles.

The objective of the present invention is to provide a dust filtering apparatus for a computer system that can be easily changed if desired.

Another objective of the present invention is to provide a dust filtering apparatus for a computer system that reduces the amount of time involved, from the development of an archetype module to the commercialized version of the product.

One other objective of the present invention is to provide a dust filtering apparatus for a computer system, that can be assembled simply and therefore contributes to a shortening of manufacturing time, with less assembling labor and reduced product cost.

### BRIEF DESCRIPTION OF DRAWINGS

The following detailed description, given by way of an example and not intended to limit the invention to the embodiments described herein, will best be understood in conjunction with the accompanying drawings, in which:

FIG. 1 is a perspective view of a prior art dust filtering apparatus for a computer;

FIGS. 2-1 is a perspective assembly view of an embodiment according to the present invention, wherein the dust filtering apparatus is detached from the panel on the computer housing;

FIGS. 2-2 is a perspective assembly view of the embodiment according to the present invention, wherein the dust filtering apparatus is attached to the panel on the computer housing;

FIGS. 3-1 is a rear view of the dust filtering apparatus of the embodiment according to the present invention; and

FIGS. 3-2 is a front view of the dust filtering apparatus of the embodiment according to the present invention.

### DETAILED DESCRIPTION OF THE INVENTION

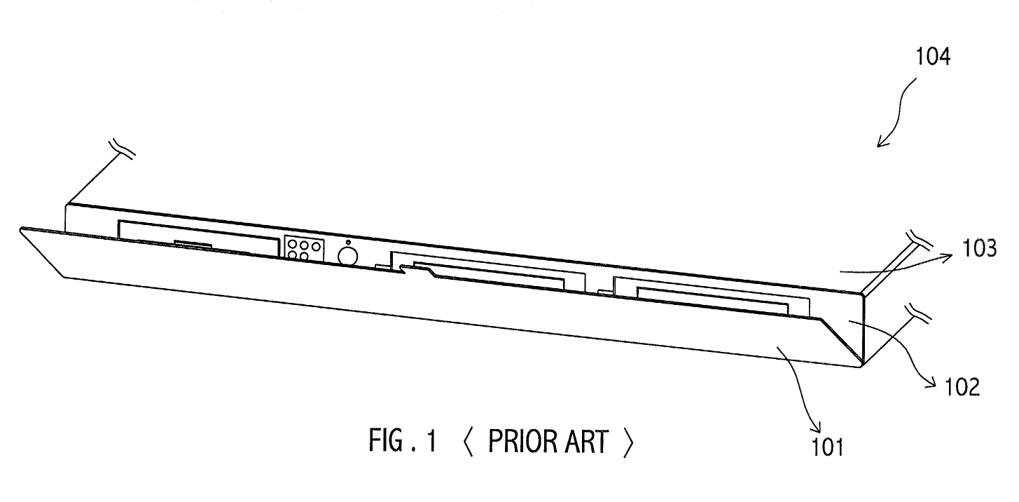

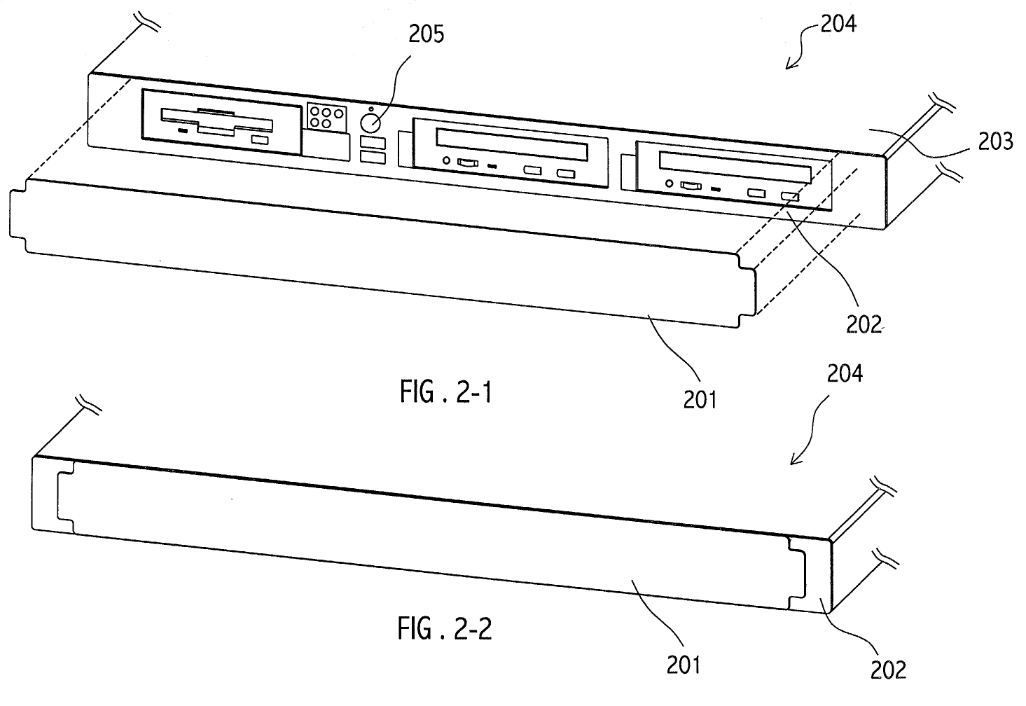

FIGS. 2-1 is a perspective assembly view of an embodiment according to the present invention. Referring to FIGS. 2-1, a computer system 204 is a server, comprising a CPU, a storage medium, an SDRAM and a motherboard. The computer housing 203 comprises a panel 202 and is made of metallic materials able to magnetically attach to other materials. The computer housing 203 is used to accommodate the computer components in the computer system 204. The panel 202 is a rectangle, comprising at least one unshielded area 205. The unshielded area can be the vent opening of the exhaust fans, a disk drive slot, optical disk drive slot or computer component port, for example a USB port, mouse PS2 port, monitor port etc. When the panel is not protected by a dust filtering apparatus, air circulates through the unshielded area 205 and thus causes dust to enter the computer housing 203. The dust may further accumulate on the surface of the components of the computer system 204.

As shown in FIGS. 2-1, the dust filtering apparatus for a computer system according to the invention is a detachable dust filtering apparatus 201. The detachable dust filtering apparatus 201 has an area approximating to the area of the panel. In other words, the detachable dust filtering apparatus 201 is large enough to cover the unshielded area 205 of the panel 202. The detachable dust filtering apparatus 201 is magnetically attached to the panel 202, by a first dust filtering member 301 attached to the detachable dust filtering apparatus 201.

The detachable dust filtering apparatus 201 comprises a first dust filtering member 301 and a second dust filtering member 302, wherein the two members are bonded together with adhesive. In addition, the first dust filtering member 301 and the second dust filtering member 302 can be formed in one piece or the second dust filtering member 302 can be embedded in the first dust filtering member 301.

The rear view and front view of the detachable dust filtering apparatus 201 according to the present invention are shown in the FIGS. 3-1 and 3-2.

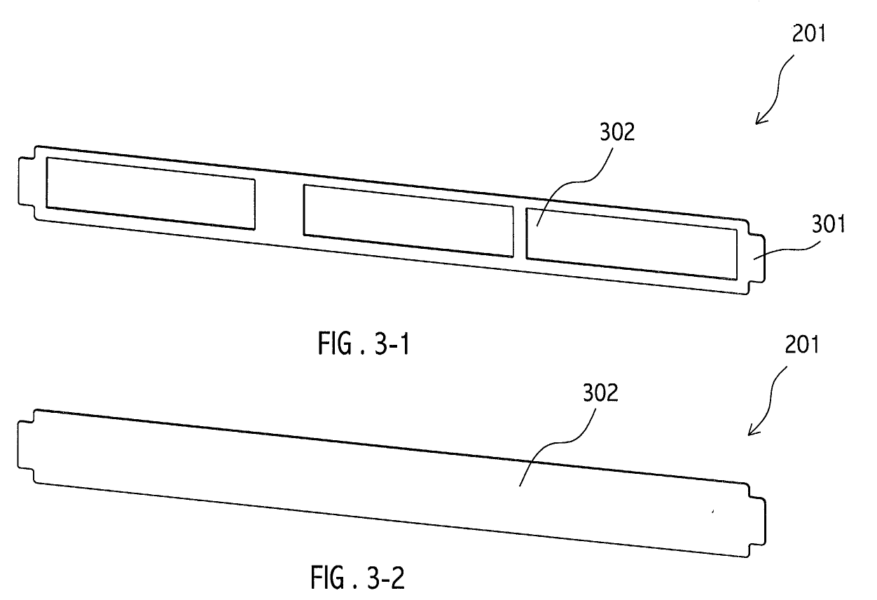

FIGS. 3-1 shows the rear view of the detachable dust filtering apparatus 201 of the preferred embodiment according to the present invention. As shown in the FIGS. 3-1, the first dust filtering member 301 is a rectangular soft magnet. The first dust filtering member 301 is also the frame of the detachable dust filtering apparatus 201 comprising three air vent openings.

FIGS. 3-2 is front view of the detachable dust filtering apparatus 201 of the preferred embodiment according to the present invention. As shown in the FIGS. 3-2, the second dust filtering member 302 covers the first dust filtering member 301 on the detachable dust filtering apparatus 201. The second dust filtering member 302 of the detachable dust filtering apparatus 201 is made of gas porous material.

The present invention utilizes a detachable dust filtering apparatus 201 to prevent dust particles entering the computer system 204 by covering unshielded area 205 of the panel 202 of the computer housing 203. The detachable dust filtering apparatus 201 can be easily installed onto the computer housing 203. Only one step is required for a user to complete the installation of the detachable dust filtering apparatus 201 to the panel 202 of the computer housing 203. The one step installation is further illustrated in FIGS. 2-1 and 2-2. FIGS. 2-1 illustrates a status where the detachable dust filtering apparatus 201 is detached from the panel 202 of the computer housing 203. Whereas FIGS. 2-2 illustrates a status where the detachable dust filtering apparatus 201 is attached to the panel 202 of the computer system 204.

While the above-mentioned embodiment is illustrated as a preferred embodiment of the invention, it is apparent that the material used to make the panel in the preferred embodiment must be not only metallic but also magnetic. Alternatively, magnetic material can be adhered to the dust filtering apparatus, allowing it to be attached to the metallic panel of the computer housing.

While the invention has been described with reference to various illustrative embodiments, the description herein should not be construed in a limiting sense. Various modifications of the illustrative embodiments, as well as other embodiments of the invention, will be apparent to those skilled in the art upon reference to this description. It is therefore contemplated that the appended claims will cover any such modifications or embodiments as may fall within the scope of the invention defined by the following claims and their equivalents

What is claimed is:

1. A computer system comprising:
computer housing used for accommodating the computer components of the computer system, the computer housing having a panel; and
at least one dust filtering apparatus magnetically attached to the panel, with an area approximate to the area of the panel.

2. The computer system of claim 1, wherein the computer system further comprises a CPU, a storage medium, an SDRAM and a motherboard.

3. The computer system of claim 1, wherein the computer housing possesses the property of attracting magnetic materials.

4. The computer system of claim 1, wherein the dust filtering apparatus is magnetic.

5. A dust filtering apparatus for a computer system comprising:
a first dust filtering member having an area approximate to the area of the panel and at least one opening, the first dust filtering member being attached to the panel by magnetism; and
a second dust filtering member, having an area approximate to the area of the first dust filtering member, the second dust filtering member being bonded to and covering the first dust filtering member.

6. The apparatus of claim 5, wherein the computer housing used for accommodating the computer components in the computer system possesses the property of attracting magnetic materials.

7. The apparatus of claim 5, wherein the first dust filtering member is magnetic.

8. The apparatus of claim 5, wherein the first dust filtering member is made of magnetic materials.

9. The apparatus of claim 5, wherein the second dust filtering member is made of gas porous material.

10. A dust filtering apparatus for a computer system, the computer system being shielded by computer housing and forming a panel having at least one opening, comprising:
a magnetic frame having an area approximate to the area of the panel and an opening, wherein the magnetic frame is attached to the panel; and
a dust filtering sheet is bonded to the magnetic frame and covers the opening.

11. A computer system comprising:
computer housing used for accommodating the computer components of the computer system, the computer housing having at least one opening; and,
a dust filtering apparatus with an area large enough to cover the opening of the computer housing;
wherein, the dust filtering apparatus is magnetically attached to the computer housing.
